(19) United States
(12) Patent Application Publication
(10) Pub. No.: US 2026/0298104 A1
(43) Pub. Date: Oct. 1, 2026

(54) GAS TURBINE GENERATOR

(71) Applicant: HONDA MOTOR CO., LTD., Tokyo (JP)

(72) Inventors: Kazuki ICHIKAWA, Saitama (JP); Naoki ITO, Saitama (JP)

(21) Appl. No.: 19/563,148

(22) Filed: Mar. 11, 2026

(30) Foreign Application Priority Data
Mar. 31, 2025 (JP) 2025-059150

(51) Int. Cl. F01D 15/10; F01D 25/24; H02K 7/00; H02K 7/08; H02K 7/18

(52) U.S. Cl. CPC F01D 15/10; F01D 25/24; H02K 7/003; H02K 7/083; H02K 7/1823; F05D 2220/76

(57) ABSTRACT

A gas turbine generator includes: a rotary shaft integrally including first and second shaft portions extending in an axial direction on a same axis; a hollow shaft provided with a hollow part which extends in the axial direction and in which the second shaft portion is inserted, the hollow shaft being fitted on the second shaft portion to be slidable in the axial direction; a compressor wheel and a turbine wheel coupled to the first shaft portion to be torque-transmittable; a generator rotor coupled to the hollow shaft to be torque-transmittable; and a first fixing member detachably fixed to an end portion of the second shaft portion opposite from the first shaft portion, wherein the hollow shaft and the rotary shaft have opposing end surfaces that oppose and contact each other to restrict a movement of the hollow shaft in the axial direction in cooperation with the first fixing member.

### TECHNICAL FIELD

The present invention relates to a gas turbine generator.

### BACKGROUND ART

There is known a combined power system in which a gas turbine engine and a rotary electric machine are connected, and an output shaft of the gas turbine engine and a rotor shaft of the rotary electric machine are coupled to each other on the same axial line (for example, JP2022-157785A).

In this combined power system, the rotor shaft of the rotary electric machine is composed of a hollow shaft and a solid shaft disposed in a hollow part of the hollow shaft and rotates integrally with the hollow shaft. The hollow shaft is rotatably supported by a housing of the rotary electric machine, and the axial movement thereof relative to the housing is restricted by screw-engagement of a nut member or the like. A compressor wheel is splined to the output shaft of the gas turbine engine and to the hollow shaft. Further, in the hollow part of the hollow shaft, the solid shaft and the output shaft are coupled by screw engagement.

In the aforementioned conventional technology, in order to separate the gas turbine engine and the rotary electric machine from each other at the time of maintenance or the like, it is necessary to release the restriction on the axial movement of the hollow shaft relative to the housing by removing the nut member, and to release the screw engagement between the solid shaft and the output shaft by rotating the solid shaft and the output shaft relative to each other. Therefore, the workability of separating and reassembling the gas turbine engine and the rotary electric machine is poor.

### SUMMARY OF THE INVENTION

In view of the foregoing background, an object of the present invention is to provide a gas turbine generator in which the workability related to separating a gas turbine device part and an electric generator part at the time of maintenance or the like is improved.

To achieve the above object, one aspect of the present invention provides a gas turbine generator, comprising: a turbine housing defining a compressor chamber and a turbine chamber arranged in an axial direction; a generator housing which is coupled to one end portion of the turbine housing to be detachable in the axial direction and defines a rotor chamber; a rotary shaft integrally including a first shaft portion extending in the axial direction inside the turbine housing and a second shaft portion extending in the axial direction inside the generator housing, the first shaft portion and the second shaft portion being located on a same axis; a hollow shaft provided with a hollow part which extends in the axial direction and in which the second shaft portion is inserted, the hollow shaft being fitted on an outer circumference of the second shaft portion to be slidable in the axial direction; a first bearing rotatably supporting the first shaft portion in the turbine housing; a second bearing and a third bearing rotatably supporting the hollow shaft in the generator housing; a compressor wheel coupled to the first shaft portion in the compressor chamber to be torque-transmittable; a turbine wheel coupled to the first shaft portion in the turbine chamber to be torque-transmittable; a combustor provided in the turbine housing; a generator stator having a cylindrical shape and fixed in the generator housing; a generator rotor coupled to the hollow shaft to be torque-transmittable and positioned inside the generator stator; and a first fixing member detachably fixed to an end portion of the second shaft portion opposite from the first shaft portion, wherein the hollow shaft and the rotary shaft have opposing end surfaces facing each other, and a movement of the hollow shaft in the axial direction with respect to the rotary shaft is restrained by the first fixing member and contact between the opposing end surfaces.

According to the above aspect, the workability of separating the gas turbine device part and the electric generator part is improved.

### BRIEF DESCRIPTION OF THE DRAWINGS

FIG. 1 is a vertical sectional view showing a gas turbine generator according to an embodiment of the present invention; and

FIG. 2 is an explanatory diagram showing a separated state of the gas turbine generator according to the embodiment.

### DETAILED DESCRIPTION OF THE INVENTION

In the following, an embodiment of the present invention will be described in detail with reference to the drawings.

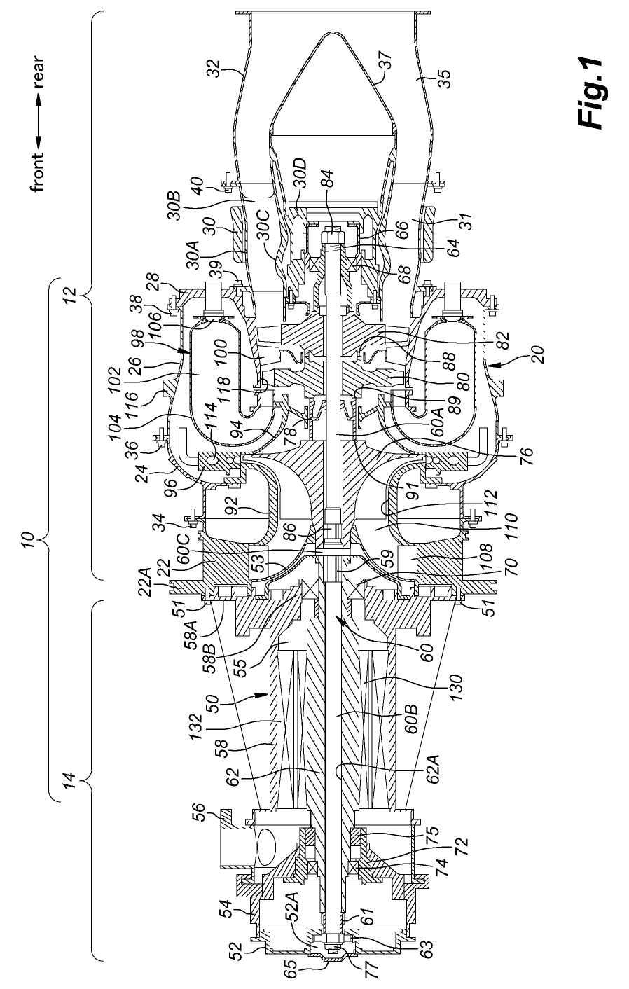

As shown in FIG. 1, a gas turbine generator 10 according to the present embodiment includes a gas turbine device 12 and an electric generator 14. In the following description, the side on the electric generator 14 will be referred to as the front side (the left side as viewed in FIG. 1), and the side on the gas turbine device 12 will be referred to as the rear side (the right side as viewed in FIG. 1).

The gas turbine device 12 includes a turbine housing 20. The turbine housing 20 includes, in order from the front side, an end plate-like front end housing 22, a first intermediate housing 24 and a second intermediate housing 26 which are cylindrical in shape, an end plate-like third intermediate housing 28, and a fourth intermediate housing 30 and a rear housing 32 which are cylindrical in shape, where these housings are arranged on the same axis. Ones of these housings 22, 24,26, 28, 30, and 32 adjacent to each other in the axial direction (the left-right direction as viewed in FIG. 1) are separably joined to each other by bolts 34, 36, 38, and 40.

The electric generator 14 includes a generator housing 50 disposed on the same axis as the turbine housing 20. The generator housing 50 includes, in order from the front side, an end plate-like front end housing 52, a first intermediate housing 54, a second intermediate housing 56, and a rear housing 58 on the same axis, where the first intermediate housing 54, the second intermediate housing 56, and the rear housing 58 are cylindrical in shape. Ones of these housings 52, 54, 56, and 58 adjacent to each other in the axial direction are separably joined to each other by bolts or the like (not shown in the drawings) to define a rotor chamber 55. The second intermediate housing 56 is a housing for drawing out the electric power cable (not shown in the drawings) of the electric generator 14 to the outside of the generator housing 50 and is made of resin. The second intermediate housing 56 may be insert molded onto the first intermediate housing 54. An end wall member 53 is attached to the rear end of the rear housing 58.

At the central part of the turbine housing 20 and the generator housing 50, a rotary shaft 60 is disposed to extend in the axial direction. The rotary shaft 60 integrally includes a first shaft portion 60A positioned in the turbine housing 20, a second shaft portion 60B positioned in the generator housing 50, and a flange part 60C provided between the first shaft portion 60A and the second shaft portion 60B and having an outer diameter greater than those of the first shaft portion 60A and the second shaft portion 60B.

On the outer circumference of the second shaft portion 60B, a hollow shaft 62 is fitted to be removable in the axial direction, and the hollow shaft 62 is coupled to the second shaft portion 60B to be torque-transmittable by a first spline 59. Specifically, the hollow shaft 62 is provided with a hollow part 62A which extends in the axial direction and in which the second shaft portion 60B is inserted. In other words, the hollow shaft 62 is fitted onto the outer circumference of the second shaft portion 60B to be removable in the axial direction and is coupled to the second shaft portion 60B to be torque-transmittable by the first spline 59. The rear end surface (the opposing end surface) of the hollow shaft 62 and the front surface (the opposing end surface) of the flange part 60C face and contact each other.

A support structure for the rotary shaft 60 and the hollow shaft 62 will now be described.

The fourth intermediate housing 30 of the turbine housing 20 integrally includes an outer tubular part 30A, an inner tubular part 30C concentrically disposed inside the outer tubular part 30A by coupling plate parts 30B, and a bearing mount tubular part 30D continuous with the inner tubular part 30C and concentrically disposed inside the inner tubular part 30C. The outer tubular part 30A and the inner tubular part 30C define an exhaust passage 31 having a cross section in an annular shape. At the rear end of the inner tubular part 30C, a flow-straightening cone 37 is attached. The flow-straightening cone 37 is disposed in an exhaust passage 35 defined by the rear housing 32.

An inner sleeve 64 is fitted on the outer circumference of a part of the first shaft portion 60A in the vicinity of the rear end thereof. An outer sleeve 66 is fitted in the inner circumference of the bearing mount tubular part 30D. A rear rolling bearing 68 is mounted between the outer circumference of the inner sleeve 64 and the inner circumference of the outer sleeve 66. Thereby, the turbine housing 20 rotatably supports a part of the rotary shaft 60 in the vicinity of the rear end thereof with the rear rolling bearing 68.

The rear housing 58 of the generator housing 50 has an annular part 58B in the vicinity of the rear end thereof. An intermediate rolling bearing 70 is mounted between the inner circumference of the annular part 58B and the outer circumference of a part of the hollow shaft 62 in the vicinity of the rear end thereof. Thereby, the generator housing 50 rotatably supports the part of the hollow shaft 62 in the vicinity of the rear end thereof with the intermediate rolling bearing 70.

A bearing mounting sleeve 72 is attached to the first intermediate housing 54 of the generator housing 50. A front rolling bearing 74 and an oil seal member 75 are mounted between the inner circumference of the bearing mounting sleeve 72 and the outer circumference of a part of the hollow shaft 62 in the vicinity of the front end thereof. Thereby, the turbine housing 20 rotatably supports the part of the hollow shaft 62 in the vicinity of the front end thereof with the front rolling bearing 74.

The front end housing 52 has a recess 52A that opens forward. The front end of the second shaft portion 60B protrudes into the recess 52A. A first nut 77 is screwed onto the front end of the second shaft portion 60B inside the recess 52A. Thereby, the hollow shaft 62 is fixed to the second shaft portion 60B in a state in which the hollow shaft 62 is clamped between the front surface of the flange part 60C and the rear surface of the first nut 77 via a sleeve 61 and a resolver sensor 63, which are removably mounted on the outer circumference of a part of the second shaft portion 60B in the vicinity of the front end thereof, with a predetermined axial force and the axial movement thereof with respect to the second shaft portion 60B is restrained. A cap 65 for closing the recess 52A is detachably mounted to the front end housing 52. The hollow shaft 62 is clamped between the front surface (the opposing end surface) of the flange part 60C and the rear surface (the opposing end surface) of the first nut 77 (the first fixing member) screwed onto a part of the second shaft portion 60B in the vicinity of the front end thereof with an axial force, whereby the axial movement thereof with respect to the second shaft portion 60B is restrained.

The front end of the front end housing 22, in other words, the front end of the turbine housing 20 is formed with a flange part 22A having an annular shape. The rear end of the rear housing 58, in other words, the rear end of the generator housing 50 is formed with a flange part 58A having an annular shape. The front surface (the opposing end surface) of the flange part 22A of the turbine housing 20 and the rear surface (the opposing end surface) of the flange part 58A of the generator housing 50 face each other in the axial direction. The flange part 22A of the turbine housing 20 and the flange part 58A of the generator housing 50 are detachably joined by bolts 51.

On the first shaft portion 60A of the rotary shaft 60, a compressor wheel 76, a spacer 78, a front-stage turbine wheel 80, a rear-stage turbine wheel 82, and an inner sleeve 64 are fitted in order from the front side. These components are clamped in the axial direction between the rear surface of the flange part 60C and the front surface of a second nut 84 (the second fixing member) screwed onto the rear end of the first shaft portion 60A, and the axial movement of these components with respect to the first shaft portion 60A is restrained with a predetermined axial force.

The compressor wheel 76 is coupled to the first shaft portion 60A via a second spline 86 in a torque-transmittable manner. The front-stage turbine wheel 80 and the rear-stage turbine wheel 82 are coupled to be torque-transmittable by a curvic coupling 88. The spacer 78 is coupled to the front-stage turbine wheel 80 by a curvic coupling 89 in a torque-transmittable manner and is coupled to the compressor wheel 76 by a curvic coupling 91 in a torque-transmittable manner.

Thereby, the rotation of the front-stage turbine wheel 80 and the rear-stage turbine wheel 82 is transmitted to the compressor wheel 76 via the spacer 78, and is further transmitted to the first shaft portion 60A via the compressor wheel 76.

Inside the turbine housing 20, partition wall members 92 and 94 having a cone shape, a diffuser 96, a combustor 98, and a stator blade member 100 having an annular shape are provided. Due to these, the turbine housing 20 defines, in order from the front side, an air inlet 108, a compressor chamber 112, a diffuser passage 114, a compressed air passage 116, and a turbine chamber 118.

The combustor 98 includes a combustion chamber container 104 that defines a combustion chamber 102 having an annular cross section, and fuel injection nozzles 106 mounted to the combustion chamber container 104 for injecting fuel into the combustion chamber 102.

The compressor wheel 76 is disposed in the compressor chamber 112. The front-stage turbine wheel 80 and the rear-stage turbine wheel 82 are disposed in the turbine chamber 118. The stator blade member 100 is disposed between the front-stage turbine wheel 80 and the rear-stage turbine wheel 82.

The air (outside air) taken in from the air inlet 108 to the air introduction passage 110 flows to the compressor chamber 112 and is compressed by the rotation of the compressor wheel 76 to make compressed air. The compressed air flows through the diffuser passage 114 and the compressed air passage 116 into the combustion chamber 102. In the combustion chamber 102, the air-fuel mixture composed of the fuel injected into the combustion chamber 102 from the fuel injection nozzles 106 and the compressed air is combusted to generate combustion gas.

The combustion gas flows into the turbine chamber 118 and rotationally drives the front-stage turbine wheel 80 and the rear-stage turbine wheel 82. As a result of the rotation of the front-stage turbine wheel 80 and the rear-stage turbine wheel 82, the rotary shaft 60 and the hollow shaft 62 rotate integrally with the front-stage turbine wheel 80 and the rear-stage turbine wheel 82.

The combustion gas that has passed the turbine chamber 118 flows through the exhaust passages 31 and 35 and is discharged rearward to the atmosphere as exhaust gas.

A generator rotor 130 is mounted on the outer circumference of the hollow shaft 62. A cylindrical generator stator 132 is mounted on the inner circumference of the rear housing 58. The generator rotor 130 is positioned inside the generator stator 132. The generator rotor 130 rotates integrally with the hollow shaft 62 and generates electricity.

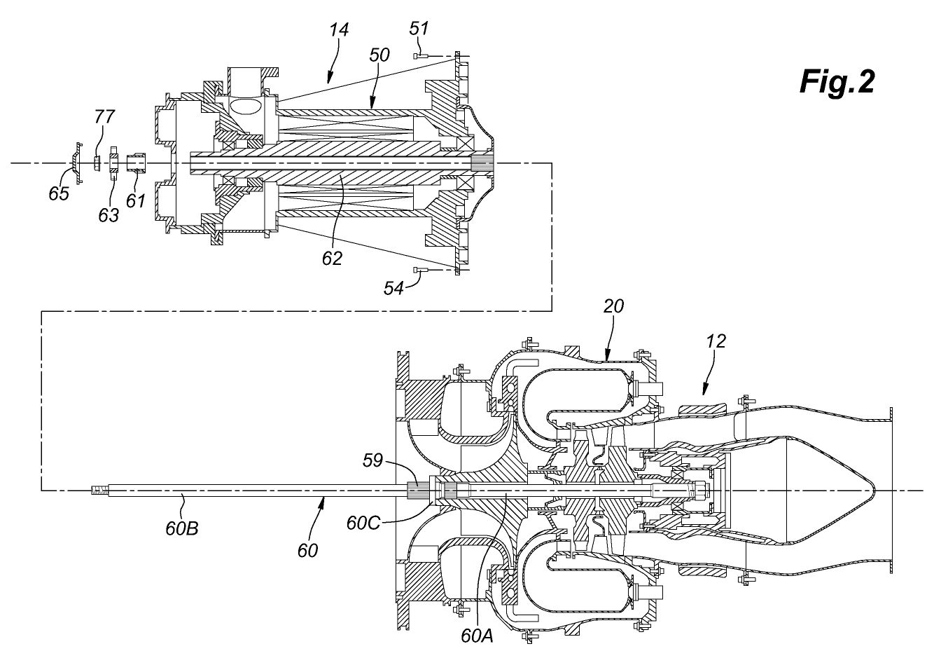

When the gas turbine device 12 and the electric generator 14 are separated as shown in FIG. 2 at the time of maintenance or the like of the gas turbine generator 10, first, the cap 65 is detached from the front end housing 52, and the first nut 77 is loosened and detached from the second shaft portion 60B. Thereafter, the resolver sensor 63 and the sleeve 61 are removed from the second shaft portion 60B.

Next, the bolts 51 are loosened and detached to release the joining of the turbine housing 20 and the generator housing 50 by the bolts 51. Then, the hollow shaft 62 and the generator housing 50 as a whole are moved in the axial direction (leftward as seen in FIG. 2) with respect to the second shaft portion 60B of the rotary shaft 60, with the first spline 59 sliding in the axial direction, to remove the hollow shaft 62 from the second shaft portion 60B of the rotary shaft 60. Thereby, separation of the electric generator 14 and the gas turbine device 12 completes. When reassembling them, the reverse of the above separation work may be performed.

In this way, the work of separating and reassembling the gas turbine device 12 and the electric generator 14 can be performed with good workability without requiring complicated work.

When the front-stage turbine wheel 80 and the rear-stage turbine wheel 82 are detached from the rotary shaft 60 at the time of maintenance or the like of the gas turbine device 12, first, the turbine housing 20 is disassembled, and the second nut 84 is detached. Next, the front-stage turbine wheel 80 and the rear-stage turbine wheel 82 are moved together with the inner sleeve 64 in the axial direction (rightward as seen in FIG. 2) with respect to the first shaft portion 60A of the rotary shaft 60 to remove the front-stage turbine wheel 80 and the rear-stage turbine wheel 82 from the first shaft portion 60A.

Since the axially adjacent ones of the compressor wheel 76, the spacer 78, the front-stage turbine wheel 80, and the rear-stage turbine wheel 82 are coupled to each other by the curvic couplings 88, 89, and 91, the fit of the front-stage turbine wheel 80, the spacer 78, and the rear-stage turbine wheel 82 on the first shaft portion 60A may be a loose fit. Due to this, the front-stage turbine wheel 80, the spacer 78, and the rear-stage turbine wheel 82 can be removed from the first shaft portion 60A easily, and the workability of disassembling the gas turbine device 12 improves.

When removing the compressor wheel 76 from the rotary shaft 60, the compressor wheel 76 is moved in the axial direction (rightward as seen in FIG. 2) with respect to the first shaft portion 60A of the rotary shaft 60, with the second spline 86 sliding in the axial direction, to remove the compressor wheel 76 from the first shaft portion 60A. Thereby, the compressor wheel 76 is detached from the rotary shaft 60 with good workability.

In the foregoing, the present invention has been described in terms of the preferred embodiment thereof, but as can be easily appreciated by a person of ordinary skill in the art, the present invention is not limited by such an embodiment, and various modifications are possible without departing from the spirit of the present invention.

For example, the structure for coupling the hollow shaft 62 to the second shaft portion 60B of the rotary shaft 60 to be slidable in the axial direction and to be torque-transmittable is not limited to the first spline 59, and may be a sliding key, a serration, or the like.

If the intermediate rolling bearing 70 consists of a rolling bearing with a small axial displacement between the inner race and the outer race of the bearing as an angular ball bearing, the restriction of the rearward axial movement of the hollow shaft 62 with respect to the rotary shaft 60 may be achieved by the rear end surface (the opposing end surface) of the generator housing 50 contacting the front end surface (the opposing end surface) of the turbine housing 20, instead of the contact between the rear end surface (the opposing end surface) of the hollow shaft 62 and the front surface (the opposing end surface) of the flange part 60C of the rotary shaft 60. The front surface of the flange part 60C of the rotary shaft 60 may be configured by an end surface of a step resulting from a difference in the outer diameter at an intermediate portion of the rotary shaft 60.

The rear rolling bearing 68 and the front rolling bearing 74 may be roller bearings. When the rear rolling bearing 68 and the front rolling bearing 74 are roller bearings which permit movement in the axial direction, an axial adjustment margin may be provided between the rear end or the front end of the rotary shaft 60 and the turbine housing 20 or the generator housing 50.

The first fixing member detachably attached to the front end part of the second shaft portion 60B and the second fixing member detachably attached to the rear end part of the first shaft portion 60A are not limited to the first nut 77 and the second nut 84, and may be any removable fasteners such as wedges placed on the shaft portion to apply a necessary axial force to the members on the shaft portion.

The sleeve 61 may be used as a nut of the first fixing member. In this case, the first nut 77 fixes only the resolver sensor 63, and it becomes unnecessary to adjust the axial force when replacing the resolver sensor 63. Thus, workability of the maintenance of the gas turbine generator improves further.

Instead of the electric generator 14, an electric motor may be coupled to the gas turbine device 12 as a rotating machine. In this case, a combined rotational driving device in which each of the electric motor and the gas turbine device functions as a rotational driving device is configured.

Also, not all of the components shown in the above embodiment are necessarily indispensable and they may be selectively adopted as appropriate without departing from the spirit of the present invention.

The above embodiment may be described as follows.

One embodiment is a gas turbine generator 10, comprising: a turbine housing 20 defining a compressor chamber 112 and a turbine chamber 118 arranged in an axial direction; a generator housing 50 which is coupled to one end portion of the turbine housing to be detachable in the axial direction and defines a rotor chamber 55; a rotary shaft 60 integrally including a first shaft portion 60A extending in the axial direction inside the turbine housing and a second shaft portion 60B extending in the axial direction inside the generator housing, the first shaft portion 60A and the second shaft portion 60B being located on a same axis; a hollow shaft 62 provided with a hollow part 62A which extends in the axial direction and in which the second shaft portion is inserted, the hollow shaft 62 being fitted on an outer circumference of the second shaft portion to be slidable in the axial direction; a rear rolling bearing 68 (the first bearing) rotatably supporting the first shaft portion in the turbine housing; an intermediate rolling bearing 70 (the second bearing) and a front rolling bearing 74 (the third bearing) rotatably supporting the hollow shaft in the generator housing; a compressor wheel 76 coupled to the first shaft portion in the compressor chamber to be torque-transmittable; a turbine wheel (the front-stage turbine wheel 80 and the rear-stage turbine wheel 82) coupled to the first shaft portion in the turbine chamber to be torque-transmittable; a combustor 98 provided in the turbine housing; a generator stator 132 having a cylindrical shape and fixed in the generator housing; a generator rotor 130 coupled to the hollow shaft to be torque-transmittable and positioned inside the generator stator; and a first fixing member (the first nut 77) detachably fixed to an end portion of the second shaft portion opposite from the first shaft portion, wherein the hollow shaft and the rotary shaft have opposing end surfaces facing each other, and a movement of the hollow shaft in the axial direction with respect to the rotary shaft is restrained by the first fixing member and contact between the opposing end surfaces.

According to this aspect, the workability of separating the gas turbine device part and the electric generator part can be improved.

In the above aspect, the gas turbine generator may further comprise a first spline 59 that couples the hollow shaft and the second shaft portion to be slidable in the axial direction and to be torque-transmittable.

According to this aspect, the hollow shaft and the first shaft portion can be favorably coupled to be slidable in the axial direction and torque-transmittable.

In the above aspect, the first fixing member may include a first nut 77 screwed onto the second shaft portion.

According to this aspect, the fixing member can be realized easily.

In the above aspect, the rotary shaft may include, between the first shaft portion and the second shaft portion, a flange part 60C having an outer diameter greater than outer diameters of the first shaft portion and the second shaft portion, and an end surface of the flange part on a side of the second shaft portion may constitute the opposing end surface of the rotary shaft.

According to this aspect, the contact between the rotary shaft and the hollow shaft in the axial direction is achieved favorably.

In the above aspect, the gas turbine generator may further comprise a second spline 86 that couples the compressor wheel to the first shaft portion to be slidable in the axial direction and to be torque-transmittable.

According to this aspect, the compressor wheel can be detached from the first shaft portion easily.

In the above aspect, the gas turbine generator may further comprise: a curvic coupling (the curvic couplings 88, 89, and 91) that couples the turbine wheel and the compressor wheel to each other; a second fixing member (the second nut 84) detachably fixed to an end portion of the first shaft portion opposite from the second shaft portion, wherein the turbine wheel and the compressor wheel are clamped between the flange part and the second fixing member with a predetermined axial force.

According to this aspect, a torque can be transmitted reliably between the turbine wheel and the compressor wheel, and the workability of detaching the turbine wheel from the first shaft portion improves.

In the above aspect, the second fixing member may include a second nut 84 screwed onto the first shaft portion.

According to this aspect, the second fixing member can be realized easily.

1. A gas turbine generator, comprising:
a turbine housing defining a compressor chamber and a turbine chamber arranged in an axial direction;
a generator housing which is coupled to one end portion of the turbine housing to be detachable in the axial direction and defines a rotor chamber;
a rotary shaft integrally including a first shaft portion extending in the axial direction inside the turbine housing and a second shaft portion extending in the axial direction inside the generator housing, the first shaft portion and the second shaft portion being located on a same axis;
a hollow shaft provided with a hollow part which extends in the axial direction and in which the second shaft portion is inserted, the hollow shaft being fitted on an outer circumference of the second shaft portion to be slidable in the axial direction;
a first bearing rotatably supporting the first shaft portion in the turbine housing;
a second bearing and a third bearing rotatably supporting the hollow shaft in the generator housing;
a compressor wheel coupled to the first shaft portion in the compressor chamber to be torque-transmittable;
a turbine wheel coupled to the first shaft portion in the turbine chamber to be torque-transmittable;
a combustor provided in the turbine housing;
a generator stator having a cylindrical shape and fixed in the generator housing;
a generator rotor coupled to the hollow shaft to be torque-transmittable and positioned inside the generator stator; and
a first fixing member detachably fixed to an end portion of the second shaft portion opposite from the first shaft portion,
wherein the hollow shaft and the rotary shaft have opposing end surfaces facing each other, and
a movement of the hollow shaft in the axial direction with respect to the rotary shaft is restrained by the first fixing member and contact between the opposing end surfaces.

2. The gas turbine generator according to claim 1, comprising a first spline that couples the hollow shaft and the second shaft portion to be slidable in the axial direction and to be torque-transmittable.

3. The gas turbine generator according to claim 1, wherein the first fixing member includes a first nut screwed onto the second shaft portion.

4. The gas turbine generator according to claim 1, wherein the rotary shaft includes, between the first shaft portion and the second shaft portion, a flange part having an outer diameter greater than outer diameters of the first shaft portion and the second shaft portion, and an end surface of the flange part on a side of the second shaft portion constitutes the opposing end surface of the rotary shaft.

5. The gas turbine generator according to claim 4, comprising a second spline that couples the compressor wheel to the first shaft portion to be slidable in the axial direction and to be torque-transmittable.

6. The gas turbine generator according to claim 5, further comprising:
a curvic coupling that couples the turbine wheel and the compressor wheel to each other; and
a second fixing member detachably fixed to an end portion of the first shaft portion opposite from the second shaft portion,
wherein the turbine wheel and the compressor wheel are clamped between the flange part and the second fixing member with a predetermined axial force.

7. The gas turbine generator according to claim 6, wherein the second fixing member includes a second nut screwed onto the first shaft portion.
